(19) United States
(12) Patent Application Publication
(10) Pub. No.: US 2025/0340455 A1
(43) Pub. Date: Nov. 6, 2025

(54) PURE WATER SUPPLYING MACHINE

(71) Applicant: ORGANO CORPORATION, Tokyo (JP)

(72) Inventors: Kazutoshi MURAKAMI, Tokyo (JP); Shuichi OKABE, Tokyo (JP); Kyosuke MATSUMURA, Tokyo (JP); Sansu KIN, Tokyo (JP); Takafumi HOSHINO, Nagano (JP)

(73) Assignee: ORGANO CORPORATION, Tokyo (JP)

(21) Appl. No.: 18/998,741

(22) PCT Filed: Jul. 6, 2023
(86) PCT No.: PCT/JP2023/025131

§ 371 Date: Jan. 27, 2025

(30) Foreign Application Priority Data
Aug. 8, 2022 (JP) 2022-126358

(51) Int. Cl. C02F 1/00; C02F 1/32; C02F 1/42; C02F 1/44; C02F 9/00

(52) U.S. Cl. CPC C02F 1/008; C02F 9/00; C02F 1/32; C02F 2001/427; C02F 1/444; C02F 2201/005; C02F 2209/20; C02F 2209/40

(57) ABSTRACT

A pure water supplying machine that is connected to a pure water production device to supply pure water in response to a request by a user, includes: a valve installed in a flow path of pure water to a discharge unit that discharges pure water; a foot controller that is operated by a foot of a user to generate a signal indicating an operation amount; and a control unit that receives the signal from the foot controller and controls the valve to have an opening degree corresponding to the operation amount.

### TECHNICAL FIELD

The present invention relates to a pure water supply machine that discharges pure water from the tip of a nozzle or tube in response to a request by a user.

### BACKGROUND ART

In laboratories and analysis rooms, when dispensing pure water into beakers and test tubes, or performing washing with pure water, a pure water supplying machine is used, which is connected to a pure water production device, receives a supply of pure water from the device, and discharges pure water from the tip of a discharge unit upon demand. The pure water supplying machine is also called a water dispenser or a pure water dispenser. For example, a nozzle, tube, hose or the like is used for the discharge unit. In the pure water supplying machine, a valve can be installed in a path of pure water leading to the discharge unit, and the valve can be controlled to switch between discharging of the pure water from the discharge unit and stopping the discharging. If a proportional control valve or the like is used as the valve, the flow rate of pure water at the time of discharge can be adjusted by the opening degree of the valve. When washing a lab ware, a larger flow rate of pure water facilitates washing, while when pouring pure water up to a marked line in a measuring flask or the like, a smaller flow rate allows for more accurate operation. Therefore, the ability to adjust the flow rate of pure water at discharge is an important element of a pure water supplying machine.

Patent Literature 1 discloses a water dispenser that uses a water dispensing gun which can be held by a user with his or her hand, and which is equipped with a nozzle that discharges pure water. In this water dispenser, a pushbutton switch and a rotary encoder connected to a wheel are installed in the water dispensing gun. Opening and closing of the valve can be controlled by the pushbutton while the opening degree of the valve during discharge can be adjusted according to the direction and amount of rotation of the wheel. Patent Literature 1 also discloses that a foot switch can control the discharge of pure water and its discontinuation.

### CITATION LIST

### Patent Literature

Patent Literature 1: JP 2020-81493 A

### SUMMARY OF INVENTION

### Technical Problem

In the water dispenser, or pure water supplying machine, described in Patent Literature 1, the flow rate of pure water discharged from the nozzle is adjusted by the user turning a wheel on the water dispensing gun with his/her finger. Some pure water supplying machines can adjust the flow rate of pure water discharged by operation on a touch panel. However, these flow rate adjustment operations are manual operations performed by the user's hands or fingers, and when pure water is used in ultra trace analysis, these manual operations may contaminate the hands, fingers, or gloves, causing contamination in the analysis. The risk of contamination increases when the flow rate is frequently adjusted. The same is true when discharging of pure water from a nozzle and stopping it are performed via a push-button switch operated by fingers. The object of the present invention is to provide a pure water supplying machine that can adjust the discharge flow rate of pure water without hand or finger operation.

### Solution to Problem

The pure water supplying machine according to the present invention is a pure water supplying machine that is connected to a pure water production device to supply pure water in response to a request by a user, including: a valve installed in a flow path of pure water to a discharge unit that discharges pure water; a foot controller that is operated by a foot of a user to generate a signal indicating an operation amount; and a control unit that receives the signal from the foot controller and controls the valve to have an opening degree corresponding to the operation amount.

In the pure water supplying machine according to the present invention, the user can adjust the flow rate of pure water discharged from the discharge unit according to the operation amount when operating the foot controller with his or her foot, for example, the operation amount of depressing or stepping on the pedal of the foot controller with his or her foot. Therefore, no pure water is discharged from the discharge unit in the state that the foot controller is not operated, and pure water is discharged at the maximum flow rate when the foot controller is operated to the maximum extent. However, the fact that the foot controller must be operated continuously to maintain a certain operation amount to continue discharging pure water at a certain flow rate, for example, the user must depress the pedal at a certain step-on amount, is not necessarily user-friendly. So, a pure water supplying machine according to the present invention can also implement a control in which the opening degree of the valve is maintained when the user performs operations on the foot controller in a predetermined sequence. If such control is implemented, the user may remove his or her foot from the foot controller after executing the predetermined sequence to achieve the desired flow rate of pure water, i.e., the user may cancel the execution of the operation, and even if the user release his or her foot from the foot controller, pure water continues to be discharged at the flow rate set by the sequence immediately before the foot is released. To stop dispensing pure water in this state, the user need only perform an operation such as stepping on the foot controller one more time, for example.

### Advantageous Effect of Invention

According to the present invention, it is possible to adjust the discharge flow rate of pure water without hand or finger operation in a pure water supplying machine.

### BRIEF DESCRIPTION OF DRAWINGS

FIG. 1 is a view illustrating a pure water supplying system according to one embodiment of the present invention;

FIG. 2 is a flowchart explaining processing in the pure water supplying machine; and

FIG. 3 is a timing diagram showing an example of operation of a pure water supplying machine.

### DESCRIPTION OF EMBODIMENTS

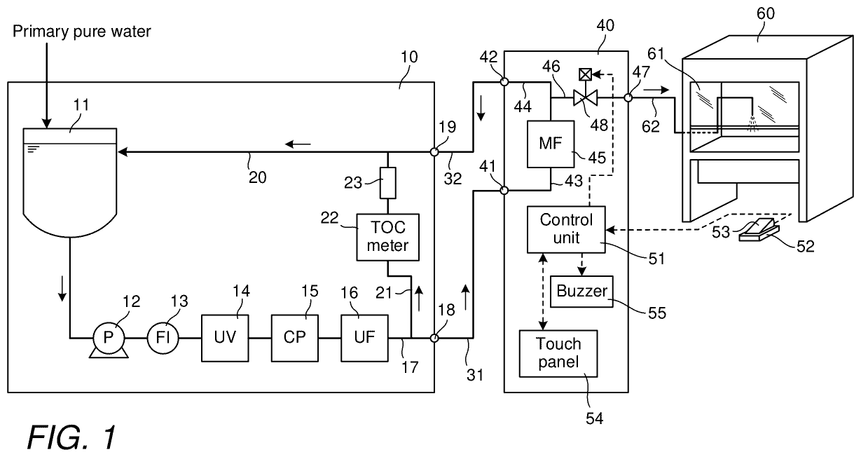

Next, embodiments of the present invention will be described with reference to the drawings. FIG. 1 shows a pure water supplying system according to one embodiment of the present invention. This pure water supplying system includes: pure water production device 10; and pure water supplying machine 40 that is connected to pure water production device 10 and receives a supply of pure water from pure water production device 10. Pure water supplying machine 40 is a pure water supplying machine based on the present invention. In the following, the pure water supplying machine based on the present invention will be described using a case in which fume hood 60 installed in a laboratory or analysis room configured as a clean room is used as a point of use and pure water is supplied from pure water supplying machine 40 into fume hood 60 in response to a request by a user. A fume hood is also called a draft chamber. Of course, in addition to the application of supplying pure water into the fume hood, the present invention can be applied to various other applications requiring dispensing of pure water.

Before describing pure water supplying machine 40, pure water production device 10 will be first described. Pure water production device 10 shown in FIG. 1 is configured as a subsystem (secondary pure water system) producing pure water by circulation purification that circulating and refining the generated pure water in the system,. Pure water production device 10 includes: storage tank 11 to which primary pure water is supplied; pump 12 connected to the outlet of storage tank 11 to feed the pure water stored in storage tank 11; flow sensor (FI) 13 connected to the outlet of pump 12; ultraviolet oxidization device (UV) 14: non-regenerative ion exchange device (CP: also called a cartridge polisher) 15 filled with a strongly acidic cation exchange resin and a strongly basic anion exchange resin in a mixed bed manner; and ultrafiltration device (UF) 16. Ultraviolet oxidization device 14, non-regenerative ion exchange device 15, and ultrafiltration device 16 are connected in this order in series to the outlet of flow sensor 13. Ultraviolet oxidation device 14 is designed to decompose total organic carbon (TOC) components in the pure water. Piping 17 is connected to the outlet of ultrafiltration device 16, and piping 21 branches off from piping 17. Piping 21 is connected to TOC meter 22 that measures the TOC concentration of the outlet water of ultrafiltration device 16. Constant flow valve 23 for making the inflow amount to TOC meter 22 is connected to the secondary side of TOC meter 22, and the outlet of constant flow valve 23 merges with piping 20 which returns to storage tank 11.

Pure water production device 10 produces pure water through circulation purification, and in the present embodiment, the pure water is circulated via pure water supplying machine 40. Therefore, the outlet of ultrafiltration device 16 is connected to circulation outlet 18 of pure water production device 10 via piping 17. Pure water production device 10 is also equipped with circulation inlet 19 for receiving pure water returned from pure water supplying machine 40, and circulation inlet 19 is connected to storage tank 11 via piping 20. As the primary pure water, for example, water obtained by passing city water through a filter, an activated carbon treatment unit, and an ion exchange device is used.

In this pure water production device 10, a circulation purification system is configured which passes through pump 12, flow sensor 13, ultraviolet oxidation device 14, non-regenerative ion exchange device 15, ultrafiltration device 16, and pure water supplying machine 40 from storage tank 11, and returns to storage tank 11. The pure water is further purified by operating pump 12 to circulate the pure water in the circulation purification system.

Pure water supplying machine 40 is connected to pure water production device 10 by piping 31 and 32. Piping 31 connects circulation outlet 18 of pure water production device 10 to circulation inlet 41 of pure water supplying machine 40, and piping 32 connects circulation inlet 19 of pure water production device 10 to circulation outlet 42 of pure water supplying machine 40. In pure water supplying machine 40, microfiltration device (MF) 45 equipped with a microfiltration membrane with a pore diameter of, for example, about 20 to 50 nm for removing particulates just before the point of use of pure water is provided as a filter cartridge. Microfiltration device 45 also forms part of the circulation purification system described above, and is supplied with pure water from circulation inlet 41 via piping 43. The pure water that has passed through microfiltration device 45 is returned to pure water production device 10 from piping 44 via circulation outlet 42. The microfiltration membrane in microfiltration membrane chamber 45 is based on, for example, polyethylene modified by sulfonic acid groups and has an ion adsorption function. By having an ion adsorption function, the microfiltration membrane can remove very small amounts of particulates and metal ions generated from the piping and fittings between pure water production device 10 and pure water supplying machine 40, enabling higher quality pure water to be provided to the user at the point of use.

To supply the pure water that has passed through microfiltration membrane device 45 to the point of use, piping 46 branches off from piping 44, and piping 46 is connected to pure water outlet 47 of pure water supplying machine 40. Proportional control valve 48, which is a solenoid valve, to control the supply of pure water to the point of use is installed in piping 46. In the example shown in FIG. 1, the point of use, which is fume hood 60, is equipped with glass window 61 that can be opened and closed in front thereof. Pure water supplying machine 40 is located proximate to fume hood 60, and tube 62 connected to pure water outlet 47 of pure water supplying machine 40 is drawn into fume hood 60. In fume hood 60, pure water is discharged from the tip of tube 62. It is preferable to use a material with low elution of particulates and metal ions, such as PFA (copolymer of tetrafluoroethylene and perfluoroalkoxyethylene), for tube 62 that is used near the point of use. When pure water is discharged directly from pure water suppling machine 40, for example, a nozzle can be attached to pure water outlet 47 and pure water can be discharged from the nozzle.

Pure water supplying machine 40 is equipped with control unit 51 that controls the opening degree of proportional control valve 48 to control the flow rate of pure water discharged from the tip of tube 62, and foot controller 52 that is operated by the user's foot is connected to control unit 51. Foot controller 52 generates a signal indicating the operation amount by the user's foot and transmits this signal to control unit 51. In the illustrated example, foot controller 52 is equipped with pedal 53 that is biased upward by a spring (not shown) or the like, and configured so that, when the user depresses or steps on pedal 53, an analog signal with an amplitude corresponding to the step-on amount is sent to control unit 51. The analog signal from foot controller 52 to control unit 51 is, for example, a current loop signal of 4 to 20 mA or a voltage signal of 1 to 5 V. Alternatively, a microprocessor may be installed in foot controller 52 to generate a digital signal representing the step-on amount of pedal 53 and send the digital signal to control unit 51. Since several modes are set in pure water supplying machine 40 for controlling the discharge flow rate of pure water as described below, pure water supplying machine 40 is also provided with touch panel 54 as an operation panel for presenting necessary information to the user and accepting input such as mode selection from the user. Touch panel 54 is connected to control unit 51. Pure water supplying machine 40 is also provided with buzzer 55, which is connected to control unit 51, in order to notify the user by sound. Instead of buzzer 55, a lamp or the like may be provided to provide notification by light.

Next, the control of the flow rate of pure water by control unit 51 will be described. Here, it is assumed that foot controller 52 generates a signal in accordance with the step-on amount of pedal 53, and that the step-on amount is expressed in the range of 0 to 100%. 0% of the step-on amount indicates that the user's foot is off pedal 53 and foot controller 52 is not being operated. On the other hand, 100% of the step-on amount indicates that pedal 53 is depressed to the maximum extent. Control unit 51 is composed of, for example, a microprocessor and receives the signal from foot controller 52 and controls proportional control valve 48 so that the opening degree of the valve is in accordance with the step-on amount. For example, control unit 51 can control proportional control valve 48 so that the opening degree is the same as the step-on amount expressed as 0 to 100%, such that: when the step-on amount is 0%, the opening degree is 0%, i.e., in the closed valve state; when the step-on amount is 50%, the opening degree is 50%; and when the step-on amount is 100%, the opening degree is 100%, i.e., the maximum opening degree. This control mode in which the opening degree is made proportional to the step-on amount is called the simple control mode.

According to the simple control mode, by changing depression of pedal 53 of foot controller 52, the user can change the flow rate of pure water discharged from the tip of tube 62 in fume hood 60 without manipulating it with his or her hand or fingers, and achieve the desired discharge flow rate.

By the way, when working with pure water, the user may want to keep the flow rate of pure water constant from a dozen seconds to several minutes or more, depending on the nature of the work. In such cases, in the simple control mode, the user must keep pedal 53 of foot controller 52 constant for a long time, which places a heavy burden on the user. Therefore, the pure water supply machine 40 of the present embodiment is equipped with a fixed opening degree mode as a control mode. The fixed opening degree mode is a control mode in which the opening degree of proportional control valve 48 is maintained based on a predetermined sequence of operations on foot controller 52 by the user. The predetermined sequence here is, for example, a predetermined sequence in depressing pedal 53. Once the opening degree of proportional control valve 48 is set in the fixed opening degree mode, even if the user subsequently releases his or her foot from foot controller 52, i.e., even if the step-on amount turns to 0%, the already set opening degree is maintained, and thus the discharge of pure water continues. To stop discharging pure water, the user simply depresses pedal 53 on foot controller 52 again. When the user wants to switch between the simple control mode and the fixed opening degree mode, the user makes the specified input on touch panel 54. Although touch panel 54 is operated by hand or finger, the switching of control modes is low frequency, and there is no contamination problem when touch panel 54 is operated by hand or finger as the control mode is switched.

The fixed opening degree mode is a control mode in which control is performed by combining two functions: the maximum opening degree fixing function and the adjustable opening degree fixing function. In the maximum opening degree fixing function, a sequence in which the step-on amount becomes equal to or more than operation judgement threshold A within predetermined operation judgment time B from the start of operation, i.e., start of step-on of foot controller 52, is assumed to be the predetermined sequence. The maximum opening degree fixing function is a function to set the opening degree of proportional control valve 48 to the maximum opening degree when there is the predetermined sequence, and thereafter, maintain this opening degree. Since the maximum opening degree fixing function is a function for setting the discharge flow rate of pure water to the maximum flow rate when the user suddenly depresses pedal 53 of foot controller 52 to the maximum, operation judgment time B is preferably less than 1 second, and, for example, 0.5 seconds. Since operation judgment threshold A is a threshold for judging whether the pedal is depressed to the maximum or not, it is set to 95%, for example, expressed in terms of the step-on amount.

In addition to the mechanism for outputting an analog signal of the strep-on amount, foot controller 52 may have a switch that is turned on if the depression is above a predetermined value and otherwise tuned off, and the signal from the switch may be sent to control unit 51. Such a switch is also called a foot switch when used alone. When such a switch is provided, the predetermined value that serves as the threshold for turning the switch on and off is set to equal to or greater than operation judgment threshold A, and the switch is used to determine whether or not the switch is stepped on to the maximum extent. When the switch is turned on within operation judgment time B from the start of the step-on of foot controller 53, control may be performed to maintain the opening degree of proportional control valve 48 at the maximum opening degree.

In the adjustable opening degree fixing function, a sequence in which the amount of variation in the step-on amount is equal to or less than predetermined variation judgement threshold C during predetermined variation judgment time D is assumed to be the predetermined sequence. The adjustable opening degree fixing function is a function to set the opening degree of proportional control valve 48 to the opening degree corresponding to the step-on amount during variation judgment time D when there is the predetermined sequence, and maintain this opening degree. The opening degree set may be in accordance with the step-on amount at the start of the corresponding variation judgement time D or in accordance with the step-on amount at the completion of variation judgement time D. The adjustable opening degree fixing function is a function to keep the flow rate of pure water at the flow rate at that time when the user keeps the flow rate of pure water almost constant for a certain period of time, i.e., over variation judgement time D. To avoid conflicts with the aforementioned maximum opening degree fixing function, variation judgment time D is set longer than operation judgment time B. If the amount of variation in the step-on amount exceeds variation judgment threshold C within the period of variation judgment time D, the clocking of variation judgment time D is terminated and the clocking is restarted at that point. Variation judgment threshold C is set to 5%, for example. If variation judgment threshold C is made too large, the opening degree may be fixed against the user's intention and the flow rate may be fixed even when the user intentionally changes the flow rate of pure water. If variation judgment threshold C is made too small, it becomes difficult to fix the flow rate by the adjustable opening degree fixing function, and the burden on the user increases.

In both the maximum opening degree fixing function and the adjustable opening degree fixing function, it is preferable to notify the user by light or sound when the opening degree of proportional control valve 48 is fixed. Compared to the maximum opening degree fixing function, where the opening degree of proportional control valve 48 is set to the maximum opening degree by suddenly depressing pedal 53 of foot controller 52 to the maximum extent, in the adjustable opening degree fixing function, the user cannot easily determine by extent of depression on pedal 53 whether the opening degree has been fixed or not. Therefore, it is particularly desirable to notify the user that the opening degree has been fixed in the adjusted opening degree fixing function.

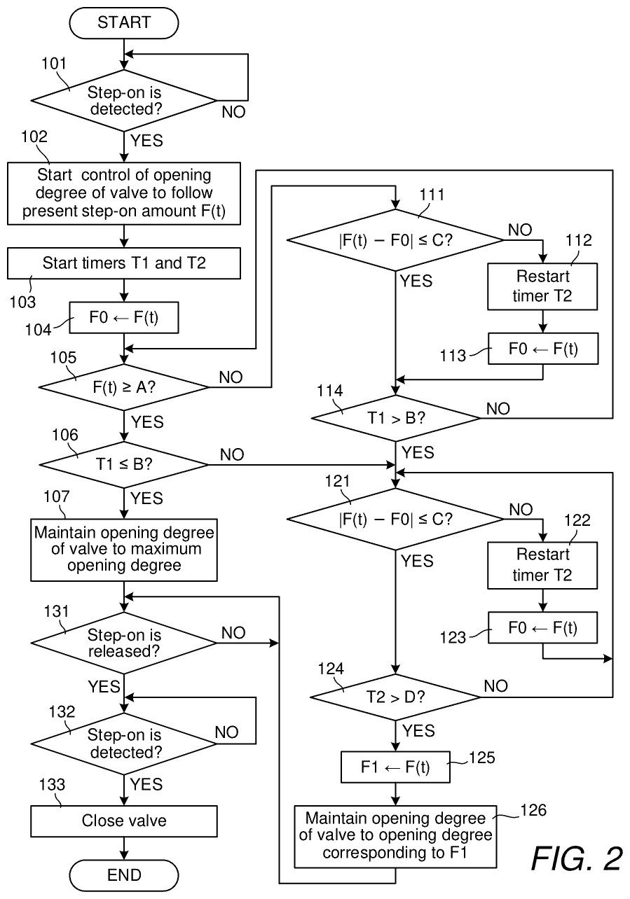

FIG. 2 shows an example of the processing performed by control unit 51 in the fixed opening degree mode. Since the step-on amount of foot controller 52 by the user can vary with time, the step-on amount is considered here as a function of time t and is represented by F(t). Initially, proportional control valve 48 is closed and the flow rate of pure water is 0, and foot controller 52 is in a state where it is not operated, specifically, the step-on amount is 0%. First, in Step 101, control unit 51 detects whether the user has stepped on pedal 53 of foot controller 52 or not, i.e., whether F(t)>0 or not. Control unit 51 waits until the user steps on the pedal, and when it is detected that the user steps on the pedal, control unit 51 starts, in Step 102, controlling the opening degree of proportional control valve 48 to follow the step-on amount F(t) as in the simple control mode. Then, in Step 103, control unit 51 starts timer T1 for measurement of operation judgment time B from 0 and timer T2 for measurement of variation judgment time D from 0, and stores current step-on amount F(t) as variable F0 in Step 104. In the following, the timed values by timers T1 and T2 are also represented by T1 and T2, respectively.

Control unit 51 then determines, in Step 105, whether or not current step-on amount F(t) is equal to or greater than operation judgment threshold A, i.e., whether F(t)≥A or not. If F(t)>A, control unit 51 determines, in Step 106, whether the value of timer T1 is within B or not, i.e., whether T1≤B or not. If T1≤B here, the step-on amount becomes equal to or more than operation judgment threshold A within operation judgment time B from the start of depressing, so based on the maximum opening degree fixing function, control unit 51 starts control to maintain the opening degree of proportional control valve 48 at its maximum opening degree in Step 107. If T1≤B is not satisfied in Step 106, operation judgment time B has already elapsed, so control unit 51 proceeds to Step 121 for processing based on the adjustable opening degree fixing function.

If F(t)≥A is not satisfied in Step 105, control unit 51 determines in Step 111 whether the amount of variation of the step-on amount is within variation determination threshold C or not, i.e., whether |F(t)−F0|≤C is satisfied or not, in order to perform processing based on the adjustable opening degree fixing function. If, in Step 111, the amount of variation is within variation determination threshold C, i.e., |F(t)−F0|≤C, control unit 51 proceeds to Step 114. If the amount of variation exceeds variation judgment threshold C in Step 111, control unit 51 restarts timer T2 in Step 112 to restart the clocking of variation judgment time D from that point and repeat the process, and assigns current step-on amount F(t) to variable F0 in Step 113. Then, control unit 51 proceeds to Step 114. In Step 114, control unit 51 determines whether T1>B or not in order to determine whether operation judgment time B, i.e., the time to perform control based on the maximum opening degree fixing function, has already elapsed. If T1>B is not satisfied, control unit 51 repeats the process from Step 105 in order to repeat the process based on the fixed opening degree fixing function. If T1>B in Step 114 and operation judgment time B has already elapsed, control unit 51 proceeds to Step 121 to continue processing based on the adjustable opening degree fixing function. If the step-on amount continues to fluctuate, the process of Steps 121 to 123 is repeated, so that the opening degree of proportional control valve 48 is not fixed.

Similar to Step 111, in Step 121, control unit 51 determines whether the amount of variation of the step-on amount is within variation determination threshold C or not, i.e., whether |F(t)−F0|≤C or not. When |F(t)−F0|≤C, control unit 51 judges in Step 124 whether T2>D or not to determine whether variation determination time D has elapsed. When T2>D, since variation determination time D has elapsed, based on the adjustable opening degree fixing function, control unit 51 substitutes the step-on amount F(t) at that time for variable F1 in Step 125, and starts, at Step 126, control of maintain the opening degree of proportional control valve 48 at the opening degree according to F1. If T2>D is not satisfied in Step 124, control unit 51 repeats the process from Step 121 to wait for the elapse of variation judgement time D. If the amount of variation of the step-on amount exceeds variation judgment threshold C in Step 121, control unit 51 restarts timer T2 in Step 122 and assigns current step-on amount F(t) to variable F0 in Step 123, as in the case of Steps 112 to 113, and then repeats the process from Step 121.

In both cases of starting control to maintain the opening degree of proportional control valve 48 by the maximum opening degree fixing function in Step 107 and starting control to maintain the opening degree of proportional control valve 48 by the adjustable opening degree fixing function in Step 126, control unit 51 judges whether the step-on is cancelled or not in Step 131 and waits until the step-on is cancelled in order to detect that the user released foot off from foot controller 52. When it is detected that the step-on has been released, control unit 51 then determines whether the user has stepped on foot controller 52 again or not in Step 132. Until the user steps on foot controller 52 again, control unit 51 waits to process, and during this time, the opening degree of proportional control valve 48 remains at the opening degree set in Step 107 or Step 126, so the pure water will continue to flow at the set flow rate. When step-on is detected in Step 132, control unit 51 closes proportional control valve 48, thereby completing a series of control of the discharge flow rate of pure water in the fixed opening degree mode, including the maximum opening degree fixing function and the adjustable opening degree fixing function. If the user releases his or her foot from foot controller 52 in this state, the state will be the same as the initial state in the series of processes described here, and if the user then operates foot controller 52 again, the above process will be repeated.

In the fixed opening degree mode, four parameters are used: operation judgment threshold A, operation judgment time B, variation judgment threshold C, and variation judgment time D. It is preferable that these four parameters, especially variation judgment threshold C and variation judgment time D, can be set by the user via touch panel 54. In actual foot controller 52, a stopper or the like may be provided to limit the range of movement of pedal 53 to prevent excessive depressing of pedal 53, and, due to the stopper, the step-on amount may not be 100% even if pedal 53 is depressed to the maximum extent with foot. Therefore, it is preferable to proceed with the process assuming that the step-on amount is 100% when the step-on amount is equal to or greater than operation judgment threshold A.

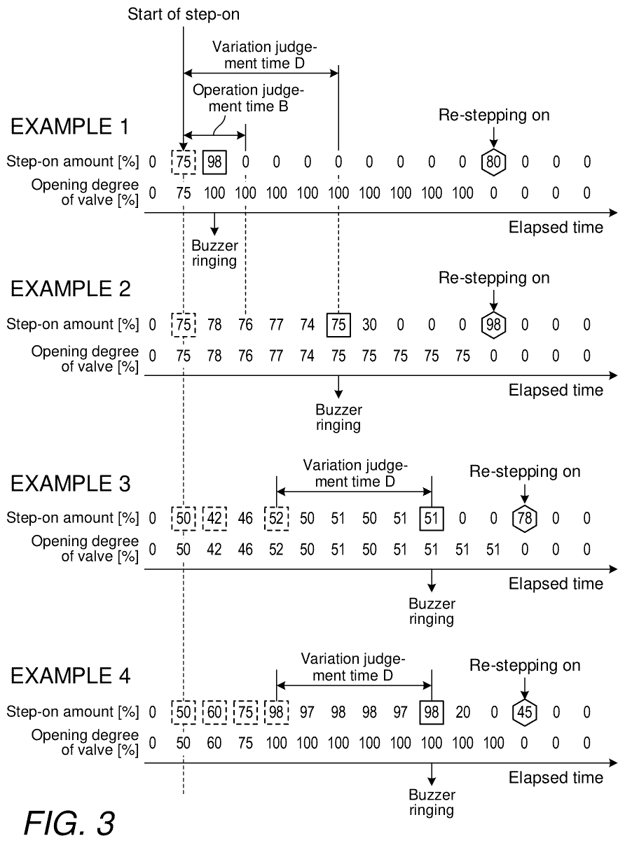

Next, an example of control of the opening degree of proportional control valve 48 by the fixed opening degree mode with the maximum opening degree fixing function and the adjustable opening degree fixing function will be explained using FIG. 3. FIG. 3 shows the time variation between the step-on amount of foot controller 52 and the opening degree of proportional control valve 46, assuming that operation judgment threshold A is 95% and variation judgment threshold C is ±5%. Here, it is assumed that the step-on amount is 100% if the step-on amount is equal to or greater than operation judgment threshold A. In the figure, some numerals indicating the step-on amount are surrounded by dashed squares, solid squares, or hexagons. The numerals surrounded by dashed squares indicate that the clocking of variation determination time D starts or restarts at that timing. The numerals surrounded by solid line squares indicate that the opening degree of proportional control valve 46 is fixed by the maximum opening degree fixing function or the adjustable opening degree fixing function at that timing. In the examples shown here, the buzzer rings at this timing. The numerals surrounded by hexagons indicate that foot controller 52 is depressed again at that timing after the opening degree is fixed and the foot is removed from foot controller 52.

In Example 1 shown in FIG. 3, the start of step-on of foot controller 52 is detected when the step-on amount goes from 0% to 75%, clocking of each of operation judgment time B and variation judgment time D starts, and proportional control valve 48 starts to be controlled so that it has the opening degree according to the step-on amount. Before operation judgment time B elapses from the start of the step-on, the step-on amount reaches 98% and becomes equal to or greater than operation judgment threshold A. As a result, based on the maximum opening degree fixing function, control is performed to maintain the valve opening degree at 100% regardless of the step-on amount, from the time when the step-on amount becomes equal to or more than operation judgment threshold A. In Example 1, the opening degree of the valve remains at 100% even when the step-on amount is 0%, i.e., the user releases his or her foot from foot controller 52. When foot controller 52 is detected to be depressed again after the step-on amount is 0%, at that point proportional control valve 48 is closed, i.e., the opening degree turns to 0%, and the flow rate of pure water turns to zero.

In Example 2 shown in FIG. 3, the start of step-on is detected as in Example 1. Here, the step-on amount does not become equal to or higher than operation judgment threshold A within operation judgment time B, but the step-on amount remains stable and the amount of variation of the step-on amount remains within variation judgment threshold C. As a result, when variation judgment time D has elapsed from the start of step-on, control is performed based on the adjustable opening degree fixing function to maintain the opening degree according to the step-on amount at that time, 75% in the example shown here. As a result, the opening degree of the valve remains at 75% even if the step-on amount is subsequently reduced to 0%. After the step-on amount becomes 0%, when re-depressing is detected, proportional control valve 48 is closed.

Example 3 shown in FIG. 3 illustrates the adjustable opening degree fixing function, similar to Example 2. In this example, the step-on amount is varying from the start of step-on, and each time the amount of variation exceeds variation judgment threshold C, the clocking of fluctuation judgment time D is restarted. After the step-on amount becomes 52% in the figure, the step-on amount stabilizes and variation judgment time D elapses as it is. After the step-on amount has stabilized, when variation judgment time D has elapsed, control is performed to maintain the opening degree according to the step-on amount at that time, 75% in the example shown here, based on the adjustable opening degree fixing function. When the step-on amount turns to 0%, and then depression occurs again, the opening degree of proportional control valve 48 turns to 0%.

Example 4 shown in FIG. 3 is similar to Example 3, but shows an example in which the adjustable opening degree fixing function is applied when the step-on amount is 95% or more, which is operation judgment threshold A. In this case, the opening degree of proportional control valve 48 is maintained at 100%.

The above described pure water supplying machine according to the present embodiment can be controlled in the fixed opening degree mode to fix the opening degree of proportional control valve 48 at a desired value by using foot controller 52, which is operated by the user's foot and generates a signal indicating the operation amount. The signal indicating the operation amount is, for example, an analog signal or a multi-level digital signal. Similar control can be also achieved using a foot switch that can detect only whether it is depressed or not. The foot switch here refers to one outputting a binary signal, i.e., an on and off signal.

In the case of using a foot switch to perform control of the fixed opening degree mode, control may be performed in which, when the foot switch is depressed and turned on, the opening degree of proportional control valve 48 is gradually increased, during the period when the foot switch is depressed, to increase the discharge flow rate of pure water, and when the user's desired flow rate is reached and the user releases his or her foot from the foot switch to turn off the switch, the opening degree at that point is maintained. After the flow rate of pure water is maintained at a certain level, when the foot switch is detected to be depressed again, the valve is closed to stop the discharge of pure water. When attempting to perform control of the fixed opening degree mode by using a foot switch in this manner, it takes time to reach the user's desired flow rate, especially the time required to maintain a constant flow rate at a large flow rate. In the present embodiment, by using foot controller 52 which generates a signal indicating the operation amount, the time required to fix the flow rate at the user's desired flow rate can be significantly reduced, thereby improving the usability of the pure water supplying machine for the user. In particular, fixing the flow rate at the maximum flow rate, which is considered to be the most frequently used, can be performed in the shortest possible time with simple operation according to the present embodiment.

### REFERENCE SIGNS LIST

10 Pure water production device;
22 TOC meter;
23 Constant flow valve;
40 Pure water supplying machine;
45 Microfiltration membrane (MF) device;
48 Proportional control valve;
51 Control unit;
52 Foot controller;
53 Pedal;
54 Touch panel;
55 Buzzer;
60 Fume hood; and
62 Tube.

1. A pure water supplying machine that is connected to a pure water production device to supply pure water in response to a request by a user, comprising:
a valve installed in a flow path of pure water to a discharge unit that discharges pure water;
a foot controller that is operated by a foot of a user to generate a signal indicating an operation amount; and
a control unit that receives the signal from the foot controller and controls the valve to have an opening degree corresponding to the operation amount.

2. The pure water supplying machine according to claim 1, wherein the control unit performs control to maintain the opening degree of the valve based on a predetermined sequence in operation by the user on the foot controller.

3. The pure water supplying machine according to claim 2, wherein the control unit controls the opening degree of the valve to a maximum opening degree when the operation amount becomes equal to or greater than an operation judgment threshold within a predetermined operation judgment time from start of the operation on the foot controller, and then performs control of maintaining the opening degree of the valve to the maximum opening degree even if the operation on the foot controller is released.

4. The pure water supplying machine according to claim 3,
wherein the foot controller is equipped with a switch that detects that the operation amount is equal to or greater than the operation judgment threshold, and
wherein the control unit performs the control of maintaining the opening degree of the valve to the maximum opening degree when the control unit receives from the switch a signal indicating that the operation amount has become equal to or greater than the operation judgement threshold within the operation judgement time from the start of the operation on the foot controller.

5. The pure water supplying machine according to claim 3, wherein the control unit performs control of closing of the valve when the foot controller is operated again after the operation on the foot controller is released.

6. The pure water supplying machine according to claim 2, wherein, when an amount of variation in the operation amount is within a predetermined variation judgment threshold over a predetermined variation judgment time, the control unit performs control of setting the opening degree of the valve to an opening degree corresponding to the operation amount during the variation judgment time, and then maintaining the opening degree of the valve at the set opening degree even if the operation on the foot controller is released.

7. The pure water supplying machine according to claim 6, further comprising:
a notification unit that informs the user with sound or light,
wherein the control unit informs the user via the notification unit when the valve is set to the opening degree corresponding to the operation amount in the variation judgement time.

8. The pure water supplying machine according to claim 6, wherein the control unit performs control of closing the valve when the foot controller is stepped on again after the operation on the foot controller is released.

9. The pure water supplying machine according to claim 6, comprising an operation panel, wherein settings of the variation judgment time and the variation judgment threshold can be changed via the operation panel.

10. The pure water supplying machine according to claim 4, wherein the control unit performs control of closing of the valve when the foot controller is operated again after the operation on the foot controller is released.

11. The pure water supplying machine according to claim 7, wherein the control unit performs control of closing the valve when the foot controller is stepped on again after the operation on the foot controller is released.

12. The pure water supplying machine according to claim 7, comprising an operation panel, wherein settings of the variation judgment time and the variation judgment threshold can be changed via the operation panel.
